(19) United States
(12) Patent Application Publication
(10) Pub. No.: US 2002/0082852 A1
(43) Pub. Date: Jun. 27, 2002

(54) System and method for "swaps" style risk products based on network enabled aggregation

(76) Inventors: David P. Greene, Ossining, NY (US); Stephen J. Boies, Mahopac, NY (US); Samuel Dinkin, Austin, TX (US); Paul Andrew Moskowitz, Yorktown Heights, NY (US); Philip Shi-Lung Yu, Chappaqua, NY (US)

Correspondence Address: Morgan & Finnegan, L.L.P., 345 Park Avenue, New York, NY, 10154, US

(21) Appl. No.: 09/748,888

(22) Filed: Dec. 27, 2000

(51) Int. Cl. G06F 17/60

(52) U.S. Cl. 705/1; 705/4; 705/38

(57) ABSTRACT

The system presented utilizes an automated “smart market” to efficiently identify individuals with contrasting interests, and allow them to enter into a contractual arrangement to balance their risks. Individuals and small corporations can register their risk profiles on a network-based server at minimal cost. Smart market software is then able to intelligently match up parties and determine terms for exchange of profits and losses by reference to current actuarial predictions of the risk event the parties have in common.

### FIELD OF THE INVENTION

The invention generally relates to the field of risk management and, in particular, to a method and system for matching parties with contrasting risk profiles, allowing them to enter into risk reducing contractual arrangements.

### BACKGROUND

Corporations and individuals regularly seek methods for reducing their risks, given the assets they hold or will obtain. In many situations, people have contrasting or offsetting positions or expectations about future events and can enter into arrangements that will reduce both parties' risks. For example, in an “interest rate swap,” two parties holding loans, one at a fixed rate, and one at a variable rate, agree to swap interest streams under a specified set of conditions designed to provide a cap on the uncertainties each face. Another area of risk offsetting behavior involves exchanging financial products called weather derivatives. Weather derivatives are financial products which are tied to weather parameters such as temperature and precipitation. While a warm winter may benefit certain parties, such as winter farmers, it may hurt other parties, such as utility companies. Parties facing this type of uncertainty can purchase weather derivatives to offset their loss, should the actual weather hurt their business or assets.

Products such as weather derivatives and interest rate swaps, however, only provide effective means of risk reduction for large corporate entities who operate on a large enough scale such that the financial and legal costs associated with such products are relatively small. These risk-offsetting products are simply not cost effective for smaller corporate entities and ordinary individuals. Furthermore, the range of risk offsetting mechanisms available is for the most part limited to risks associated with weather and interest rate fluctuations. Many individuals have more specific risk reducing needs, which are not addressed by current financial products. For example, an increase in the number of automobile accidents may benefit auto parts manufacturers and repair shops but is likely to hurt the automobile insurance industry.

### SUMMARY

The problem of inadequate risk reducing products can be solved by employing a large network like the Internet. The system and method involves matching up parties with offsetting risk profiles via network-based communication. The system, which is henceforth called the risk aggregator service, utilizes an automated “smart market” to efficiently identify individuals with contrasting interests, and allow them to enter into contractual arrangement to balance their risks. Individuals and small corporations can register their risk profiles on a network-based server at minimal cost. Smart market software is then able to intelligently match up parties and determine terms for exchange of profits and losses by reference to current actuarial predictions of the risk event the parties have in common. In addition, the risk aggregator system can itself enter into transactions with parties where the system is unable to find a party with a complementary risk profile (referred to as proprietary positions). The ability of the risk aggregator to take proprietary positions can both add liquidity to the smart market and may provide a source of added revenue.

### BRIEF DESCRIPTION OF DRAWINGS

FIG. 1 illustrates the concept of risk aggregation according to one embodiment of the system and method.

FIG. 2a illustrates one embodiment of an apparatus for use with the system and method.

FIG. 2b illustrates one embodiment of the risk aggregator shown in FIG. 2a.

FIG. 2c illustrates a sample of the contents of the request database shown in FIG. 2b.

FIG. 2d illustrates a sample of the contents of the statistical database shown in FIG. 2b.

FIG. 2e illustrates a sample of the contents of the credit database shown in FIG. 2b.

FIG. 2f illustrates a sample of the contents of the transaction history database shown in FIG. 2b.

FIG. 2g illustrates a sample of the contents of the proprietary position database shown in FIG. 2b.

FIG. 3a-3c are flow diagrams illustrating one embodiment of the system and method.

### DETAILED DESCRIPTION

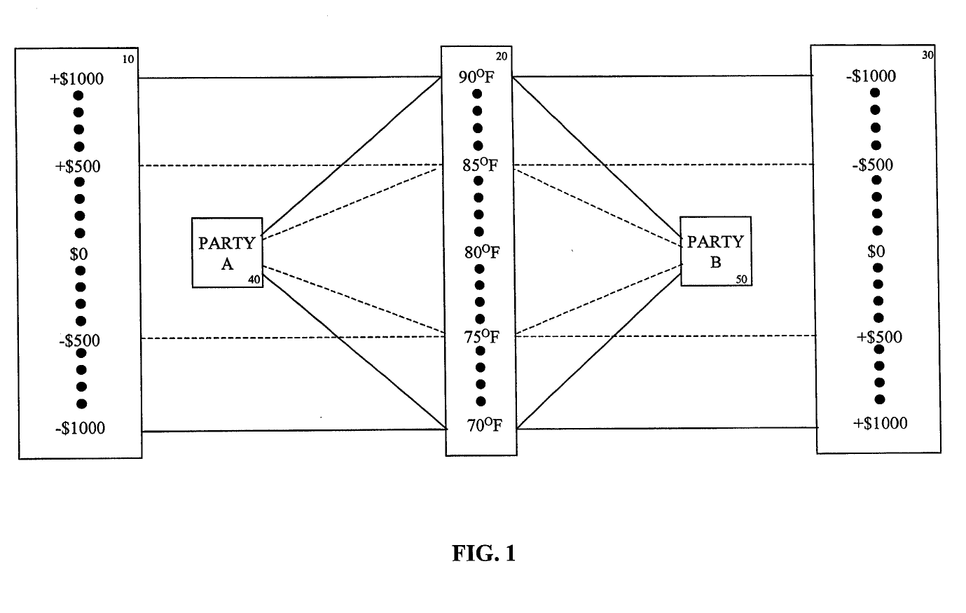

FIG. 1 illustrates the concept of risk aggregation according to one embodiment of the system and method. In this embodiment, the risk event that effects the two parties is the temperature. Assume Party A 40 and Party B 50 are small farmers, Farmers A and B. The middle column 20 represents the mean temperature during the summer, when both farmers' crops are expected to grow. The average temperature for the summer is expected to be 80° F., but it may fluctuate anywhere from 70° F. to 90° F. The optimal temperature for Farmer A's crops is 90° F. while Farmer B's crops grow best at 70°F. If the average summer temperature is 70° F., then Farmer A stands to loose $1000 dollars 60 and Farmer B stands to gain $1000 70. If the average summer temperature is 90° F., the situation is reversed 10, 30. To mitigate the degree of risk involved, Farmers A and B can enter into a contractual relationship where they agree that the party whose crops are extraordinarily profitable will pay the other party 50% of the excess profits. Thus, even if the average summer temperature falls at the extreme points of 70° F. and 90° F., neither party will ever experience a loss of more than $500, half of their original risk exposure.

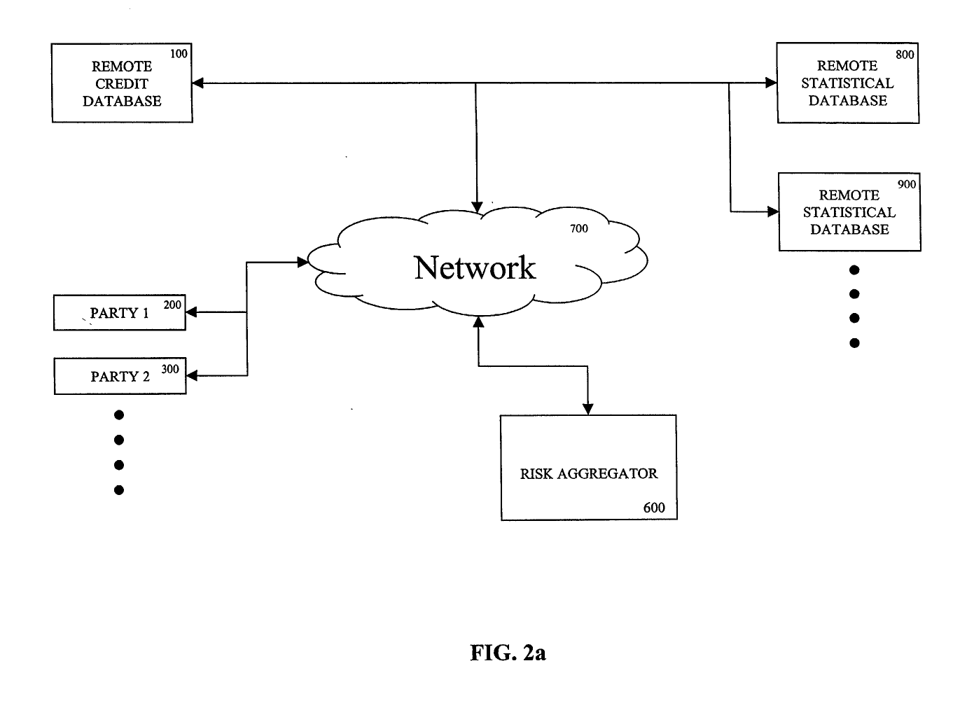

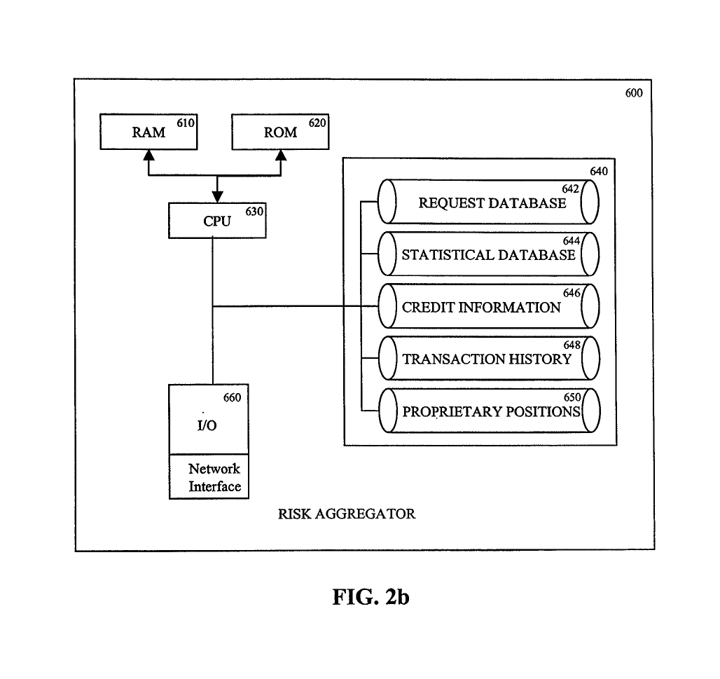

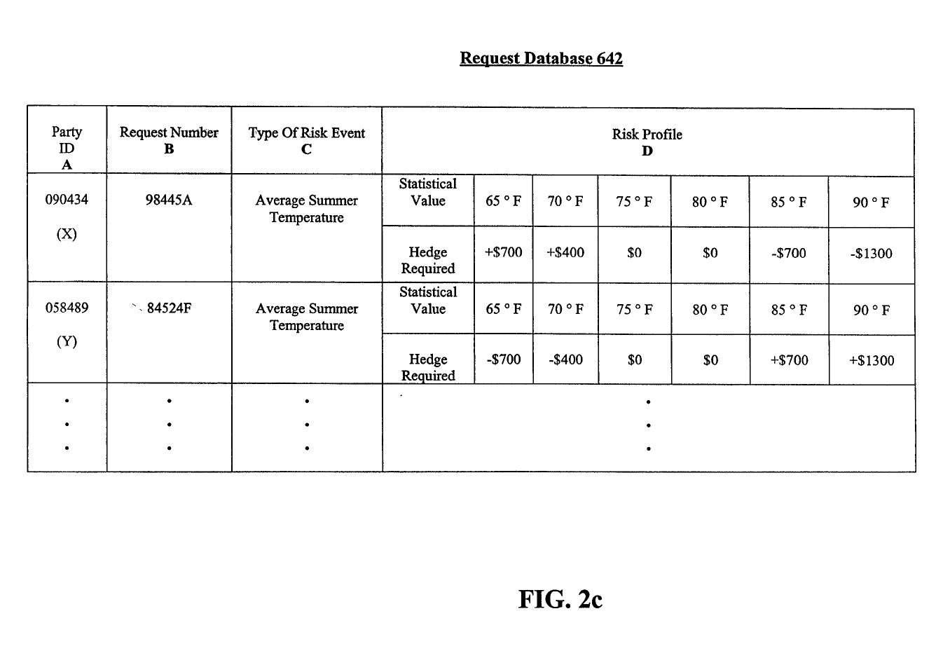

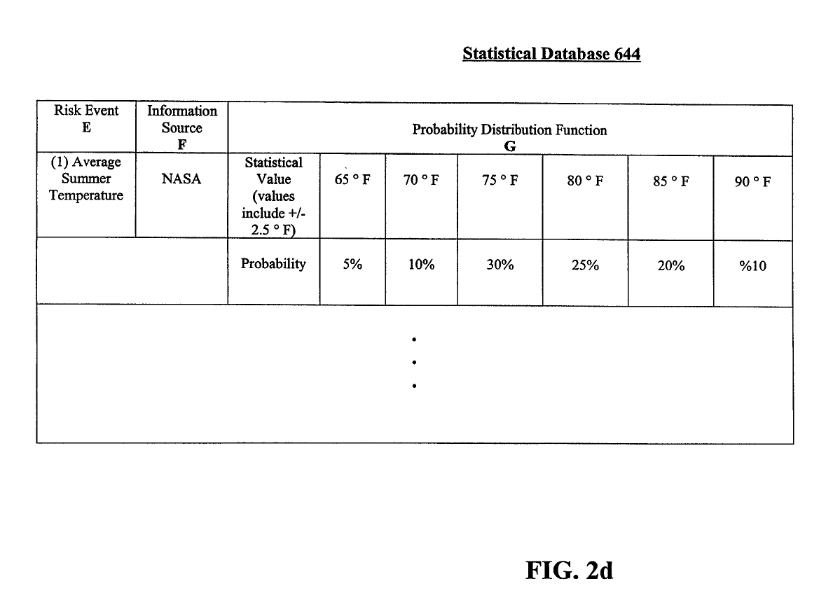

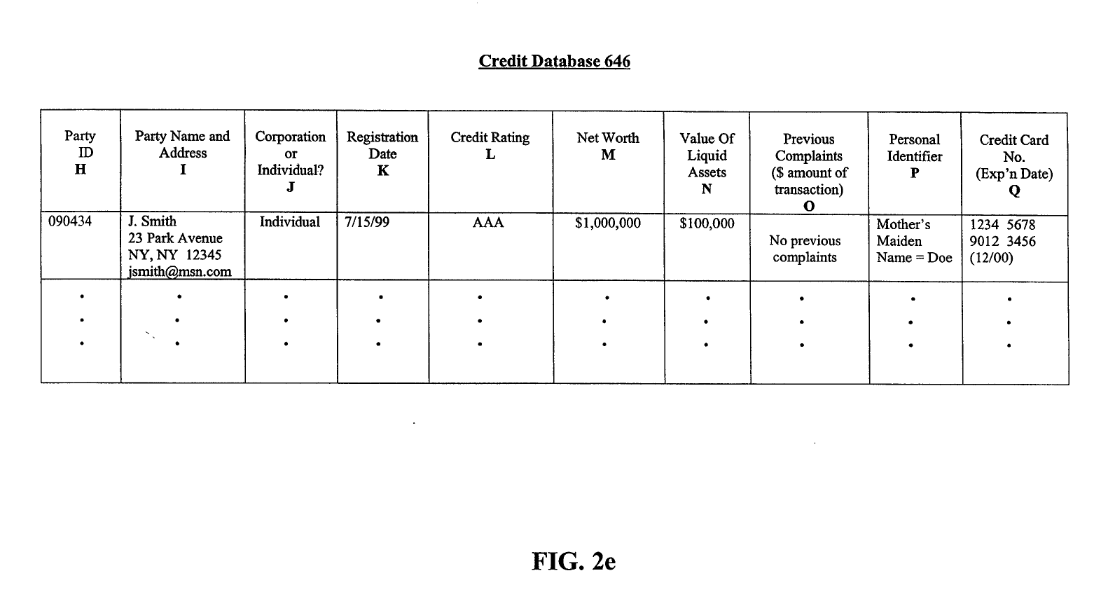

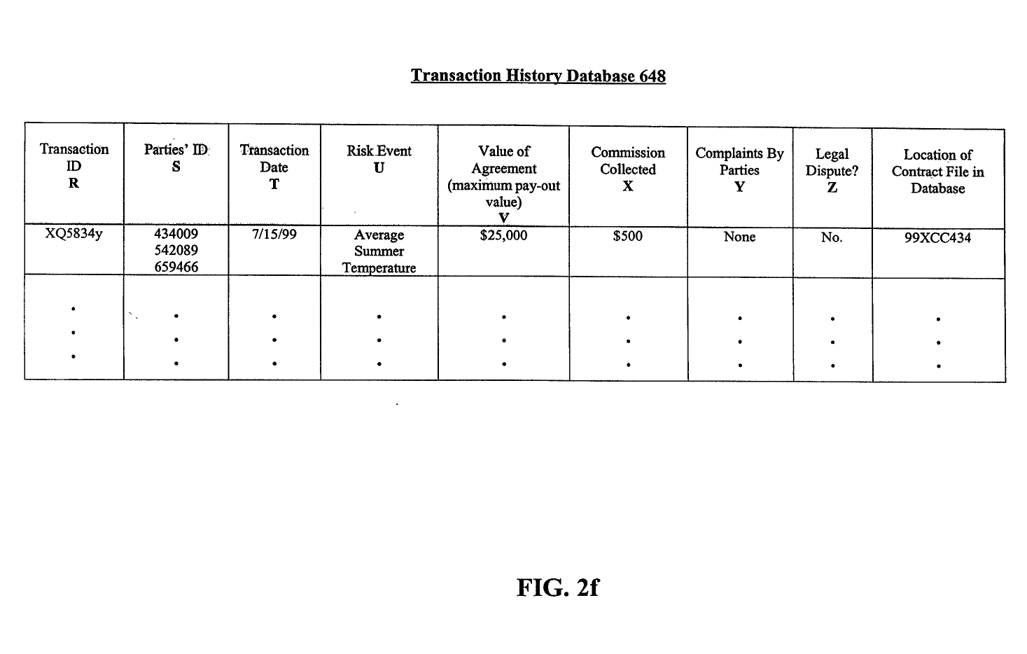

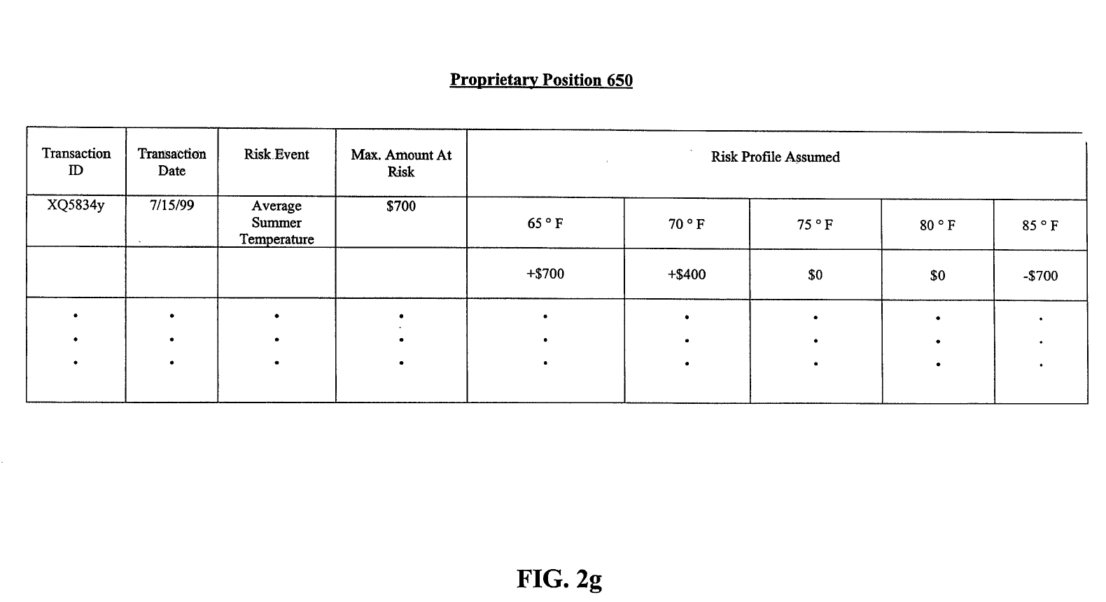

FIG. 2a illustrates a system according to one embodiment of the system and method. In this embodiment, the system includes a risk aggregator 600, configured to receive information from one or more parties 200, 300 through a network 700. Communication between the parties 200, 300 and the risk aggregator 600 is preferably accomplished electronically although it could also be accomplished with radio signals.

In one embodiment, the Internet is the network interface between the parties and the risk aggregator. In such an embodiment, parties can submit information electronically over the Internet to the Risk Aggregator 600. Communication would preferably include use of a conventional high speed modem employing known communication protocols capable of decrypting encrypted data received from the party 200. In another embodiment, the interface device may be a telephone system accessible via ordinary telephone lines. In such an embodiment, parties can transmit information by either (a) telephoning live operators at the risk aggregator 600; or by (b) telephoning automatic answering services at the risk aggregator 600 that provide programmed responses based on information received from the parties.

In one embodiment, the risk aggregator 600 is configured to receive information from remote statistical databases 800, 900. Such communication could be accomplished using either hard-wire cable lines or a wireless system.

Because the agreement between the two parties involves promises to pay under certain circumstances, in one embodiment, each party's credit information is revealed to the other party before the agreement is consummated. (See discussion infra concerning the process for revealing credit information). To accomplish this, in one embodiment, the risk aggregator 600 is connected to a remote credit database 100. The risk aggregator 600 is configured to both send and receive credit information from the credit database 100. The remote credit database can be a database held by an independent agency or a private bank. The risk aggregator 600 can also be in network connection with more than one remote credit database 100. The information received by the risk aggregator 600 is stored in a credit information database 646 discussed infra. While it is preferable that credit information is accessed remotely as illustrated in FIG. 2a, it is also possible that parties will provide authenticated credit information when registering with the risk aggregating service and that such information will be stored permanently in the credit information database 646.

FIG. 2b illustrates one embodiment of the risk aggregator 600 for the system. As shown in FIG. 2b, the risk aggregator 600 includes a central processing unit 630 (CPU), random access memory (RAM) 610, read-only memory (ROM) 620, and a database storage device 640. The CPU 630, preferably comprising a conventional microprocessor such as an Intel Pentium Processor, is electronically coupled to each of the risk aggregator's 600 other elements. The CPU executes program code stored in one of the following: RAM 610, ROM 620 or information stored in the database storage device 640, to carry out the functions and acts described in connection with the risk aggregator 600.

The database storage device 640 contains various separate databases used to store information. In one embodiment, the database storage device 640 includes a request database 642 that stores the risk information of each party. FIG. 2c illustrates the typical contents of the request database 642. As illustrated in FIG. 2c, the request database stores risk information unique to each party. Such information is used by the CPU to intelligently match up parties with complementary risk profiles. The risk information stored in the request database 642 should preferably include a definition of the risk event C that the party wants to hedge against as well as the party's risk profiles D. As illustrated in FIG. 2c in the case of temperature based risks D, risk profiles define a party's current exposure to a risk event at various eventualities and their desired or satisfactory risk exposure to the risk at these eventualities. Normally, parties will seek to smooth out their risk profiles by agreeing to transferring some of their profits in a best case scenario in exchange for a similar payment to them in their own worse case scenario. The information contained in the request database is preferably provided directly by the parties through communication with the risk aggregator 600.

In one embodiment, the database storage device 640 includes a statistical database 644 that stores current statistical information about certain risk events. The statistical database is constantly being updated with more current actuarial information provided by remote statistical databases 800, 900 which communicate with the risk aggregator. In one embodiment, the risk aggregator 600 is configured to send information to the remote statistical database, 800, 900 requesting particular statistical information depending on the types of risk events from which parties are seeking protection. In an alternative embodiment, the risk aggregator 600 will receive periodic updates of statistical information from the remote statistical databases 800, 900. In both embodiments, however, said information is stored in the statistical database 644. Said statistical information can include actuarial data on weather, interest rates and other statistical parameters. FIG. 2d illustrates how statistical information regarding temperature might be stored. As shown in FIG. 2d, the statistical information would preferably be in the form of a probability distribution function G, which includes a range of data points paired with the probability of their occurrence. Thus, in the example illustrated in FIG. 2d, there is a 30% probability that the temperature will fall out between 67.5-72.5° F. (70° F., +/−2.5° F.), while there is only a 5% chance that the temperature will fall out between 87.5-92.5° F. (90° F., +/−2.5° F.).

In one embodiment, the database storage device 640 also includes a credit information database 646. The typical contents of a credit information database 646 are illustrated in FIG. 2e. As shown in FIG. 2e, the credit information database 646 is used to store credit information on parties 200, 300 that is revealed to their transaction partners as described infra. The party's credit rating L is obtained from a remote credit database 100 which is in communication with the risk aggregator 600 as described supra. In addition, other credit information, such as the party's net worth M, and the value of their liquid assets N can be requested from the party during their registration with the risk aggregation service. The risk aggregator also keeps track of any complaints O against parties which can also be stored in the credit information database. The credit information database 646 also serves as a database of all parties that are registered with the risk aggregating service. Therefore, as shown in FIG. 2d, the credit database 646 also includes each party's individual information, including their name and address I, the date of their registration K, among others. In the preferred embodiment, this personal information is not revealed to the transaction partner and only the credit related information is revealed. In one embodiment of the credit database, a personal identifier P is also stored that allows the party to verify their own identity if they forget their ID or password. In another embodiment of the credit database, a party's credit card number or balance information Q is stored for billing or other purposes.

In yet another embodiment, the database storage device 640 includes a transaction history database 648 which records completed transactions and stores a copy of the contract between the parties. FIG. 2f illustrates the typical contents of a transaction history database 648. Such information includes the ID numbers R, S of the parties who engaged in a risk aggregating transaction, the risk event around which such parties transacted U, and the value of the agreement V. The database can also keep track of whether either party complained about the other's conduct Y and whether there was a legal dispute over the transaction Z.

In another embodiment of system and method, the database storage device 640 includes a proprietary position database 650 which records completed transactions where the risk aggregator system served as a party to the transaction. Because the risk aggregator system will need to assess its risk exposure periodically, the preferred embodiment provides for a separate database for transaction in which the system puts its own finances at risk. As shown in FIG. 2g, the proprietary position database includes, for each proprietary transaction, the date of the transaction, the maximum amount of funds at risk, and the various risk exposures at various eventualities.

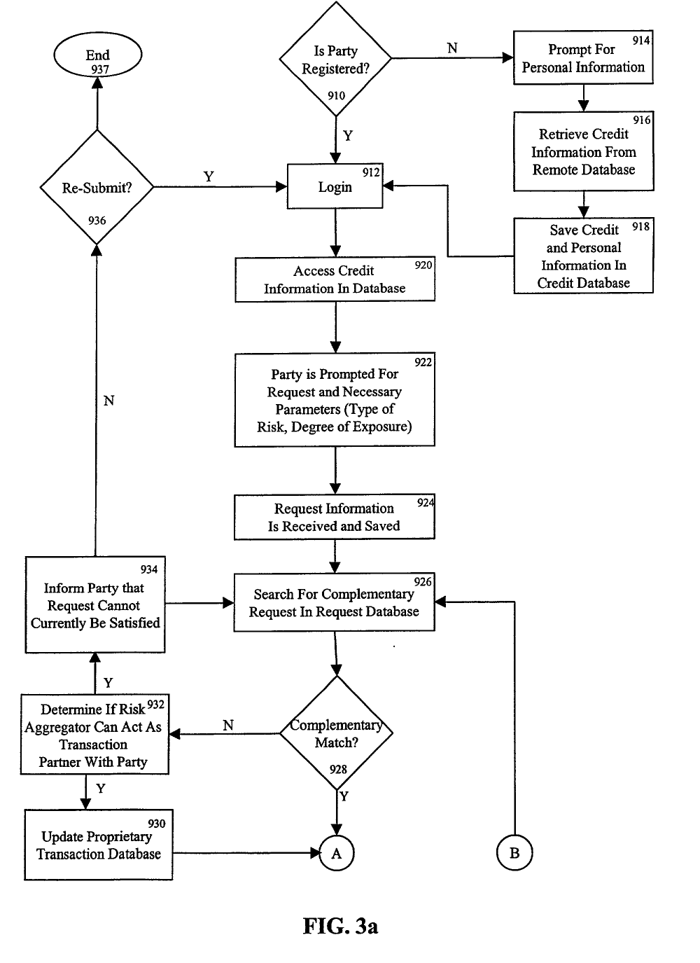

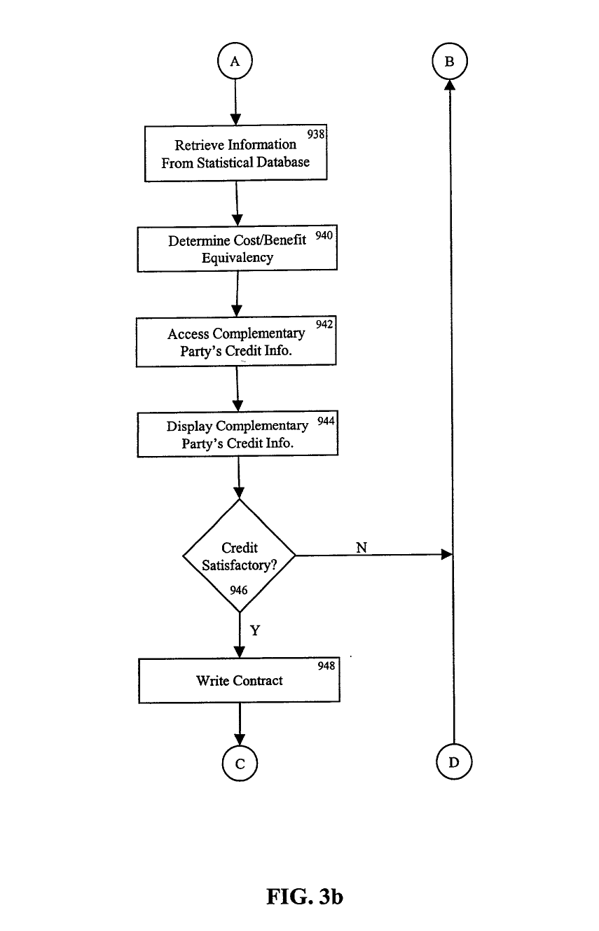

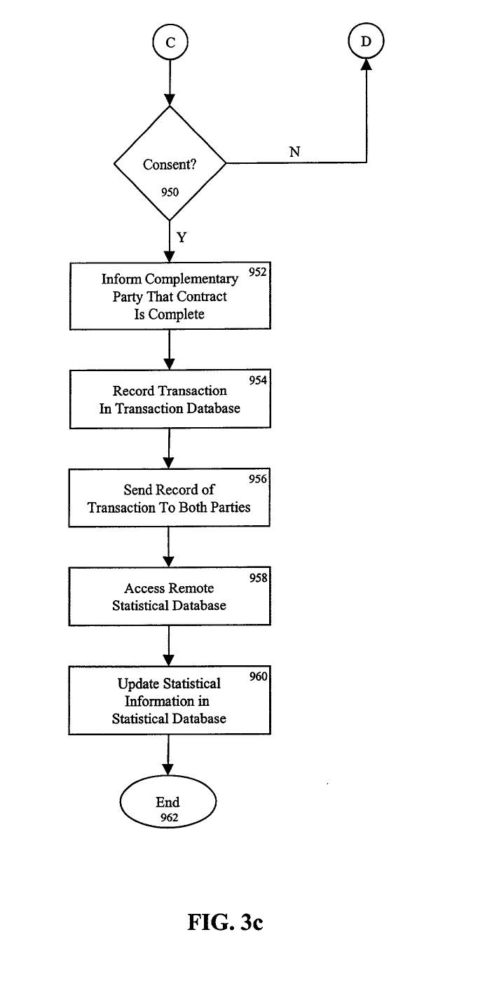

FIGS. 3a, 3b and 3c provide a illustration of an algorithm for implementing the system and method according to one representative embodiment. As shown in FIG. 3a, according to this embodiment, the party requesting risk aggregating services (henceforth referred to as the “requesting party”) is prompted by the risk aggregator to indicate if they are registered with the risk aggregation service 910. If the requesting party is not registered, then the party 200 is asked for their personal information 914. This personal information is then used by the risk aggregator 600 to communicate with a remote credit database 100 to determine the party's credit worthiness. In this way, credit information is retrieved 916 by the risk aggregator 600 and stored 918 in a credit information database 646.

After this process is complete or if the requesting party is already registered, the risk aggregator is programmed to prompt the party to login, and to accept and verify the party's login information 912. In one embodiment, each party has a unique identification number which is used to identify the party and is used by the risk aggregator service to store the party's information. In another embodiment, parties identify themselves by their name and a password which together corresponds to a particular identification number which is used internally by the risk aggregator service for storing the party's personal information.

Once the requesting party has logged into the risk aggregator service, the risk aggregator is programmed to access 920 the party's credit information in the credit information database 646. The party's credit information is then stored, temporarily, in RAM memory 610. The party is then prompted 922 to enter the risk event C that they wish to hedge against as well as the party's risk profile D with respect to this event. The party is also prompted for the risk profile which they would find satisfactory. This information is then stored in the request database 642.

After the risk aggregator has received the requesting party's request, it begins the process of searching for a contrasting request in the request database 926. A contrasting request is a request which has a risk profile around the same risk event which is the opposite of the risk profile held by another party. For example, in FIG. 1, Party A's 40 risk profile is complementary with that of Party B 50. Party A's gain or loss will always be equal to Party's B's gain or loss—for example, if the temperature is 85° F., then Party B will loose $500 while Party A will gain $500. The risk aggregator can be programmed to search the request database 642 until it has either found a matching risk profile, (or an approximate risk profile which is within an agreed upon range of approximations), or has completely searched all available risk profiles.

If no contrasting risk profile currently exists in the database 642, the risk aggregator will determine if it can act as the opposing party in the transaction 932. The risk aggregator will access the risk exposures to the same event in the proprietary position database 650. The aggregator system will also access the statistical data located in the statistical data database 644. If the risk aggregator has already taken a position on the particular risk event that the requesting party is interested in, the system will sum the system's total risk exposure to this risk event. If the risk exposure is below a pre-determined amount, the system will update the proprietary transaction database 650 to include the instant transaction 930, and the system will then engage in the transaction and follow the steps outlined below as if it was the complementary party to the transaction. Otherwise, the system will inform the party that their request cannot currently be satisfied and the system will continue searching for a match 930. In one embodiment, the system will, before continuing its search, prompt the requesting party to determine if they wish to continue searching for a complementary party. If they wish to end the search, they will be prompted to re-submit a new request 936 or end their session 937.

If the risk aggregator does find a contrasting risk profile in the request database 642, (the party with the contrasting request henceforth referred to as the “complementary party”) it can then retrieve the statistical information around which the parties are hedging 938. In one embodiment, the risk aggregator can access this information from a statistical database of information 644. The statistical database 644 can be updated periodically through communication with a remote statistical database 800, 900. In an alternative embodiment, the risk aggregator can access the relevant information from a remote statistical database 800, 900 for each particular transaction.

Once the statistical information has been retrieved, the risk aggregator can be programmed to determine the cost/benefit equivalency ratio 940. The equivalency ratio is a proportion which relates the relative risk being assumed by the parties. For example, consider again the situation of Party A and Party B illustrated in FIG. 1. The higher the temperature, the better off Party A, the lower the temperature, the better off Party B. If it was no more statistically likely that the temperature would be above 80° F. than below 80° F., then a straightforward equal transfer of money from one party to the other would suffice. (For example, if the parties wanted to reduce their risk exposure in half, they could agree that they would both transfer half of whatever profits they produced). If, however, it is more likely that the temperature will be above 80° F., then an appropriate transfer rate would have to be adjusted to take this into account. For example, if it was twice as likely that the temperature would be above 80° F. than below 80° F., then the equivalency proportion would be 2, i.e., for every dollar of excess profit Party A would agree to give to Party B in the event that the temperature was above 80° F., Party A would need to agree to give two dollars to Party B in the event that the temperature was below 80° F.

Once the equivalency ratio is determined, the risk aggregator 600 proceeds to access the complementary party's credit information from the credit information database 646. The relevant features of the complementary party's credit standing are then displayed to the requesting party. In the preferred embodiment, the personal information of the complementary party is not revealed to the requesting party along with the credit information. The requesting party is then prompted to determine if the complementary party's credit is satisfactory 946. If the requesting party accepts the complementary party's credit as satisfactory, then the risk aggregator can write a contract 948 detailing the agreed exchange of obligations using the risk profile provided by the requesting party, the risk profile provided by the complementary party when they registered their request for risk aggregation, and the equivalency ratio determined from objective statistical information about the risk event. If the requesting party rejects the complementary party's credit standing, the system will search for an alternative complementary party 926.

Once the contract is written, it is displayed to the requesting party and consent is requested. In the preferred embodiment, the system is configured such that the requesting party can provide their consent electronically. The complementary party has already provided consent by registering their risk profile in the system. (Registering=914, 916, 918). If consent is provided, then the complementary party is informed that their request has been filled 952.

Once consent is obtained, the transaction is recorded in the transaction history database 648, 954. Records of the transaction, as well as copies of the contract, are then sent to both parties 956. In one embodiment, the parties are responsible for fulfilling their obligations under the contract independent of the risk aggregator system. In an alternative embodiment, the parties can transfer funds through the risk aggregating system—this embodiment has the advantage of allowing the parties to transact entirely anonymously.

The last step involved in the system and method is updating the statistical database 644, 960. Actuarial statistics change over time, so it is important that the statistical database 644 is updated regularly. Statistical information can be retrieved from a remote statistical database 958 and transferring to the risk aggregator. After updating the statistical database, the system is ready to receive an additional request for risk aggregation.

1. Method for implementing a risk aggregation service comprising:
receiving risk profiles from users;
storing the risk profiles; and
matching contrasting risk profiles with respect to a risk event.

2. The method of claim 1 further comprising:
facilitating a risk reducing contract between users with contrasting risk profiles.

3. The method of claim 1 wherein the risk aggregator service serves as a party in the transaction.

4. The method of claim 1, wherein interaction between the users and the risk aggregation service takes place over a network.

5. The method of claim 2 wherein the facilitation of the risk reducing contract includes the incorporation of actuarial data.

6. The method of claim 5 wherein the actuarial data is obtained over a network.

7. The method of claim 2 further comprising:
ascertaining the outcome of the risk event; and
facilitating the exchange of assets agreed upon by the parties to the risk reducing contract, as determined by the outcome of the risk event.

8. The method of claim 1, wherein the risk event can be at least one of the following: the state of the weather, the real estate index, the residual value of leases, the reliability of a machine, birth statistics, death statistics, consumer price indices, marriage statistics.

9. The method of claim 1 wherein the risk profile contains a user identifier, a designation of the risk event, and a risk profile comprising the user's desired risk limiting value for various risk event outcomes.

10. An risk aggregating system comprising:
a device configured to receive risk profiles from users;
a device for storing the risk profiles; and
a device configured to match contrasting risk profiles with respect to a risk event.

11. The system of claim 10 further comprising:
a device configured to facilitate a risk reducing contract between users with complementary risk profiles.

12. The system of claim 10 wherein the risk aggregator system serves as a party in the transaction.

13. The system of claim 10, wherein interaction between the users and the risk aggregation service takes place over a network.

14. The system of claim 11 wherein the device for facilitating the risk reducing contract is configured to access actuarial data.

15. The system of claim 14 wherein the actuarial data is obtained over a network.

16. The system of claim 11 further comprising:
a device configured to ascertain the outcome of the risk event; and
a device configured to facilitate the exchange of assets agreed upon by the parties to the risk reducing contract, as determined by the outcome of the risk event.

17. The system of claim 11, wherein the risk event can be at least one of the following: the state of the weather, the real estate index, the residual value of leases, the reliability of a machine, birth statistics, death statistics, consumer price indices, marriage statistics.

18. The system of claim 1 wherein the risk profile contains a user identifier, a designation of the risk event, and a risk profile comprising the user's desired risk limiting value for various risk event outcomes.

19. A machine readable device for use with a risk aggregation service comprising:
code for receiving risk profiles from users;
code for storing the risk profiles; and
code for matching contrasting risk profiles with respect to a risk event.

20. The device of claim 19 further comprising:
code for facilitating a risk reducing contract between users with complementary risk profiles.

21. The device of claim 19 wherein the risk aggregator service serves as a party in the transaction.

22. The device of claim 19, wherein interaction between the users and the risk aggregation service takes place over a network.

23. The device of claim 20 wherein the facilitation of the risk reducing contract includes the incorporation of actuarial data.

24. The device of claim 23 wherein the actuarial data is obtained over a network.

25. The device of claim 20 further comprising:
code for ascertaining the outcome of the risk event; and
code for facilitating the exchange of assets agreed upon by the parties to the risk reducing contract, as determined by the outcome of the risk event.

26. The device of claim 19, wherein the risk event can be at least one of the following: the state of the weather, the real estate index, the residual value of leases, the reliability of a machine, birth statistics, death statistics, consumer price indices, marriage statistics.

27. The device of claim 19 wherein the risk profile contains a user identifier, a designation of the risk event, and a risk profile comprising the user's desired risk limiting value for various risk event outcomes.
